(19) United States
(12) Patent Application Publication
(10) Pub. No.: US 2005/0165650 A1
(43) Pub. Date: Jul. 28, 2005

(54) Auction profiles

(76) Inventors: Prasad V. Kothapalli, Palo Alto, CA (US); Kayhan Demirel, Mountain View, CA (US); David M Wong, Sunnyvale, CA (US); Honghua Yang, San Jose, CA (US)

Correspondence Address: FISH & RICHARDSON, P.C., PO BOX 1022, MINNEAPOLIS, MN, 55440-1022, US

(21) Appl. No.: 10/763,378

(22) Filed: Jan. 23, 2004

(51) Int. Cl. G06F 17/60

(52) U.S. Cl. 705/26

(57) ABSTRACT

Systems and techniques to create a reverse auction object having a plurality of components and assigning an auction profile, which is a set of auction rules, to the reverse auction object. The set of auction rules allow a user to control display of information to a plurality of bidders for an online reverse auction. The set of auction rules may also allow a user to control bid validation.

### BACKGROUND

The following description relates to online bidding systems, for example, a system and method for creating auction profiles.

In electronic commerce, dynamic systems for commercial transactions provide a number of advantages not available in static systems. In general, a dynamic system is one in which the characteristics of potential transactions, as well as the universe of available transactions, may change over time. An online auction is an example of a dynamic system. In contrast, a static system is one in which the characteristics of a potential transaction generally do not change. An offer to sell a product at a fixed price on a company's web site is an example of a static system.

Conventional dynamic systems for commercial transactions, such as online auction sites, generally provide companies or other entities with an efficient avenue for buying and selling goods and services. For example, an auction may be opened to a much wider range of participants when conducted online. However, conventional online systems tend to be limited in flexibility, security, and/or functionality.

### SUMMARY

The following description teaches systems and techniques for creating, modifying, copying, selecting, and deleting auction profiles in electronic or online auction systems. An “auction profile” is a set of customizable rules for controlling (a) display of auction fields and data to bidders, and (b) bid validation.

A dynamic bidding application enables an initiator, e.g., a potential purchaser of goods and/or services, at an initiator site to create objects representing opportunities, such as Request for Quotations (RFQs) and reverse auctions. RFQs and reverse auctions may include auction profiles.

In one aspect, a method creates a plurality of auction profiles. Each of said plurality of auction profiles include a subset of rules from a plurality of auction rules. The method assigns one of said plurality of auction profiles to an auction object.

The systems and techniques described here may provide one or more of the following advantages. Pre-configured auction profiles save initiators time from selecting individual auction rules to make a set of rules. An initiator or auction host may select, create or modify different auction profiles for different situations. Configurable auction profiles provide more flexibility in running auctions. An auction based on an auction object may be held as a live auction with real-time monitoring and bidding.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 shows a block diagram of an online bidding system

FIG. 2 shows a block diagram illustrating the structure of an opportunity object.

FIGS. 3 and 4 show a flowchart showing a process for creating an opportunity.

FIG. 5 is a flowchart showing a process for converting a Request for Quotation (RFQ) object into a reverse auction object.

FIG. 6 is a flowchart showing a process for validating a bid copied from an RFQ into a corresponding reverse auction object.

FIG. 7 is a screen allowing an initiator to select from among a plurality of pre-configured auction profiles and create, delete, modify and copy auction profiles.

FIG. 8 is a screen allowing a user to create an auction profile.

FIG. 9 is a table of four pre-configured auction profiles.

FIG. 10 is a table showing the behavior of a “hide until first valid bid” rule.

FIG. 11 is a flow chart showing a method of using auction profiles

FIGS. 12 and 13 are tables showing possible bidding and ranking scenarios.

Like reference symbols in the various drawings indicate like elements.

### DETAILED DESCRIPTION

The systems and techniques described here relate to an online bidding system. The online bidding system allows an initiator to create, modify, copy, select, and delete “auction profiles.” An “auction profile” is a set of customizable rules for controlling (a) display of auction fields and data (information disclosure rules), and (b) the way bids are validated (bid validation), as described below.

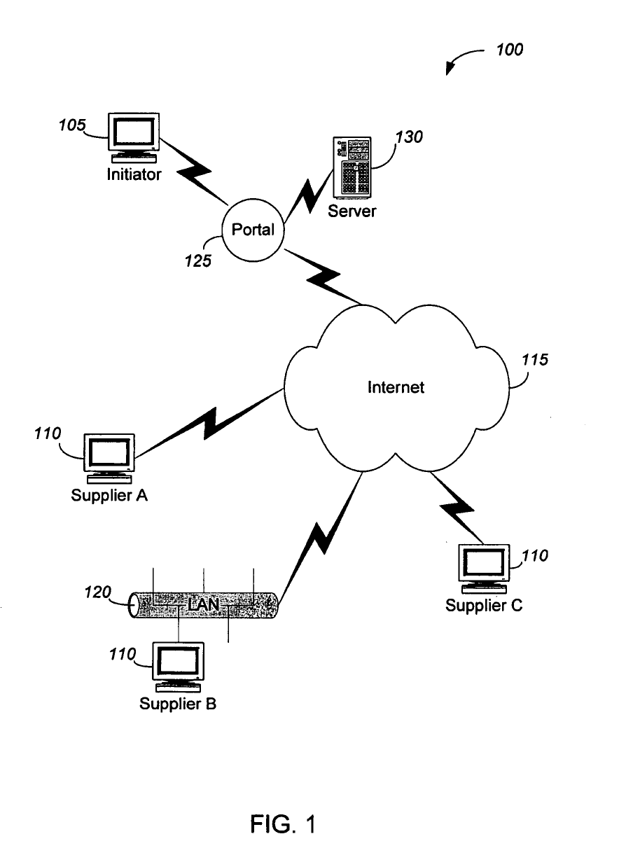

FIG. 1 illustrates a networked computer system 100. The system may include client computers at an initiator site 105 and supplier sites 110, which communicate over the Internet 115. The client computers may be connected to the Internet through other networks (e.g., local area networks 120 (LANs) or intranets) and/or a portal 125.

An initiator, e.g., a potential purchaser of goods and/or services, can use a dynamic bidding application to create opportunities on which potential suppliers may place bids. The initiator may be a human operator interacting with software running on a computer system, or an automated software process executing without human intervention, or various combinations of both. The dynamic bidding application may reside, at least partially, at the initiator site 105 and/or a server 130. The opportunities may include requests for quotations (RFQs) and reverse auctions. A “request for quotation” (RFQ) is a solicitation document used by purchasers to obtain offers for goods or services to be used in a purchasing process. RFQs generally include such information as price, delivery terms, and conditions. A “reverse auction” is an auction that uses the bid-down principle, in which the price being bid descends during the auction and the lowest bid is the winning bid. In general, the bidders are sellers or suppliers of goods or services who are offering to supply the requested good or service at the bid price. A reverse auction can provide buyers with significant cost savings by better leveraging competition among suppliers.

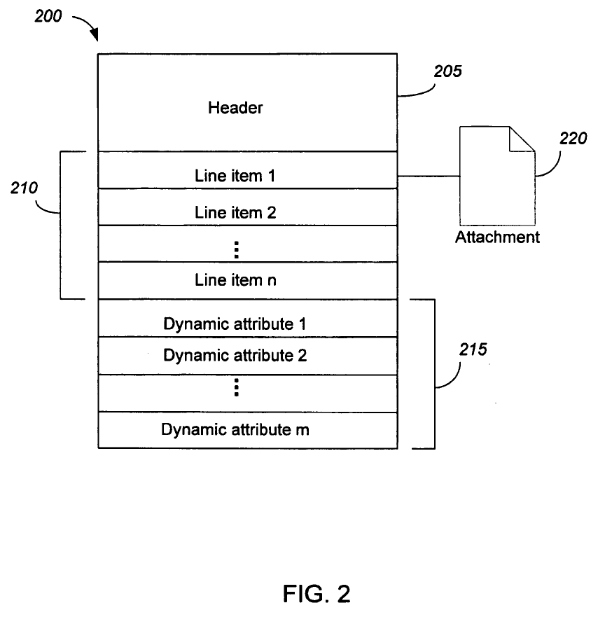

Opportunities such as RFQs and reverse auctions may be represented as objects in the dynamic bidding application. The opportunities may share a similar format 200, such as that shown in FIG. 2. An “opportunity” may include a header 205, one or more line items 210, dynamic attributes 215, and attachments 220. The header 205 may include general information about the opportunity, such as an “auction profile” (described below), classification, terms and conditions, and duration. Line items 210 identify products or services to be sourced. Dynamic attributes 215 are essentially additional fields that can be used to customize an RFQ or reverse auction for the initiator's particular needs or industry. Dynamic attributes 215 can be added to provide potential bidders with additional information or in order to obtain additional information from bidders. Attachments 220 can be of any file type and can be added to line items 210 in the opportunity.

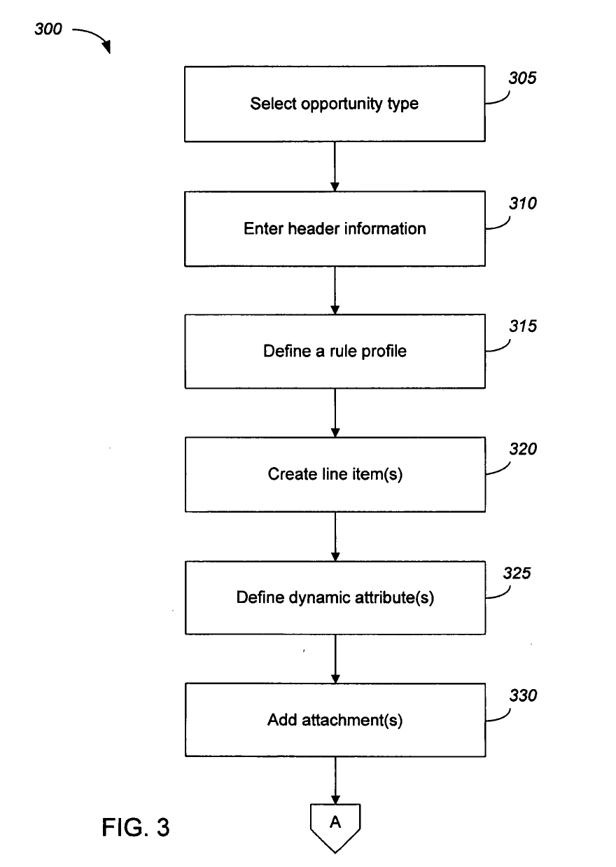

FIG. 3 is a flowchart describing a method 300 for generating an opportunity. The initiator first selects an opportunity type, e.g., RFQ or reverse auction (block 305). The initiator may then enter header information (block 310). The header information may include basic information such as a name and classification for the opportunity. The header may also include an access type for the opportunity, e.g., public or private. Public opportunities may be posted to one or more portals. Private opportunities may only be available to a defined list of suppliers, e.g., a distribution list.

The initiator may define an “auction profile” (also called a “bidding rule profile” or “rule profile”) for the opportunity in the header 205 (block 315). Auction profiles may be pre-configured, customizable sets of rules that control the behavior of the opportunity. For example, an “auction profile” may include rules for controlling (a) display of auction fields and data to bidders, and (b) bid validation. An auction profile may also enable/disable actions such as bidding and chatting, i.e., action rules.

Auction profiles for RFQs may define how a supplier can bid on the line items in the opportunity. For example, a “broken/full” RFQ auction profile may support broken lots, in which the supplier can bid for a single line item in the RFQ, but only for the full quantity of that item. A “broken/partial” RFQ auction profile may support broken lots, in which the supplier can submit a bid for any quantity of a single line item in the RFQ. A “full/full” RFQ auction profile may support only full lots, which means that bidders must submit a bid for the RFQ as a whole, i.e., all of the line items, each at full quantity. RFQ auction profiles may also define starting and closing dates and times.

Auction profiles for “reverse auctions” may include rules that allow bidders to bid on full or broken lots and full or partial quantities. Reverse auction rules may also define starting and closing date and time, starting prices, and reserve prices. The reverse auction rules may define a “sealed auction,” in which bidders are restricted from viewing any information on bids already submitted, including the identify of other bidders and whether or not theirs is the leading bid.

One type of reverse auction is a reverse “Yankee” auction, in which broken lots and partial quantities are supported. Bidders may submit bids on single line items and are not required to bid on the full quantity of that item. Bidders can also view all the information associated with other submitted bids, so strategic bidding becomes possible.

In a reverse Yankee auction, more than one winner per line item is possible, and each winning bidder pays his or her own bid price. For example, consider a reverse Yankee auction for one line item with a quantity of one hundred, a start price of $100 USD, and a close time of 09:30. Three bidders participate in the auction as follows:

Bidding Activity

| Time | Bidder | Bid Price | Bid Quantity |
|---|---|---|---|
| 09:00 | Bidder A | $100 USD | 100 |
| 09:05 | Bidder B | $80 USD | 70 |
| 09:27 | Bidder C | $90 USD | 30 |
| 09:29 | Bidder A | $89 USD | 30 |

End of Auction

In this example, Bidder B would be awarded 70 of the line items at a price of $80 USD each and Bidder A would be awarded 30 at $89 USD each. Even though Bidder A originally bid on the full quantity, Bidder A did not want to go lower than the price quoted by Bidder B. So instead, Bidder A placed a bid for the outstanding quantity at a price that still beat the next lowest bidder, even if only by $1 USD. This way, Bidder A still gets to sell a portion of his goods at a price that is satisfactory to him or her.

Once the opportunity header information has been entered, the initiators can start creating line items for the opportunity (block 320). The line items describe the goods or services the initiator wishes to procure. Line items can be added by free text entry or selected from a product master or from a catalog.

The initiator may define dynamic attributes for the opportunity (block 325). Dynamic attributes may be divided into two categories: initiator attributes and respondent attributes. Initiator attributes may be added by the initiator and completed by the initiator. Respondent attributes may be added by the initiator and completed by respondents in their bids.

Dynamic attributes may include data entry fields for the bidder to enter information. The type of data may be defined for a field, e.g., numerical (integer or floating point), textual, and yes/no (checkbox). Some examples of dynamic attribute fields might include a checkbox for indicating whether or not a process is compliant with a certain standard, a text-entry field for specifying the name and model number of a piece of equipment, and a number-entry field where the initiator can specify a required specification, e.g., the gauge of wire needed. The dynamic attributes may be defined as mandatory or not mandatory (i.e., optional).

The initiator may add attachments to an opportunity (block 330). Attachments can provide additional information about the line item, e.g., product specifications. Attachments can also contain collateral information, e.g., non-disclosure agreements. Attachments can be of any file type, and can be attached to the opportunity itself or components of the opportunity, e.g., line items.

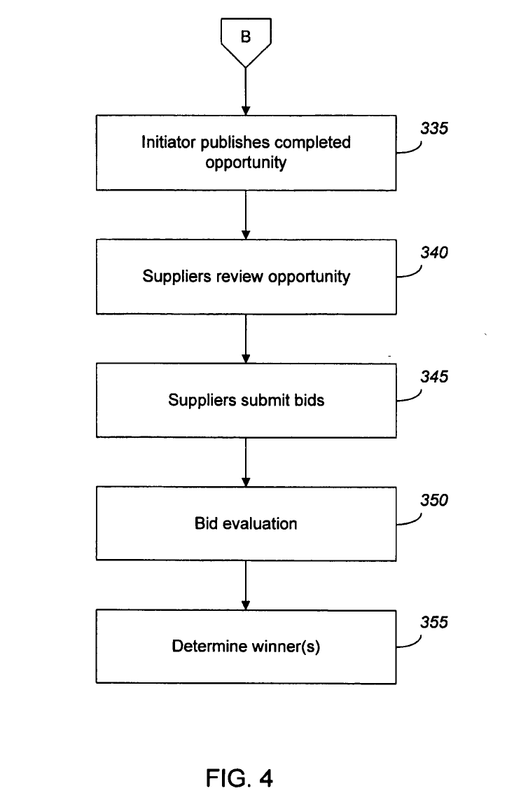

The initiator can publish the completed opportunity, e.g., to a portal if the opportunity is public, or to an invitation list consisting of distribution lists and individual users if the opportunity is not public (block 335 in FIG. 4). This allows potential suppliers the chance to review the opportunity (block 340). Once the opportunity is activated, suppliers can submit bids (block 345) on variable quantities up to the full quantity of every line item depending on whether or not the opportunity has been defined as full lot or broken lot and if partial quantities are permitted. The initiator can review bids while the opportunity is still active or wait until it has closed and all bids have been received.

The initiator can evaluate bids online for simple opportunities or offline for more complicated ones (block 350). For offline evaluation, all opportunity and bid information can be downloaded to a file, such as an Excel™ spreadsheet file.

Once the opportunity is closed, a winner may be determined (block 355). The initiator selects suppliers as the source for variable quantities up to the full quantity of every line item depending on whether or not the opportunity was defined as full lot or broken lot and if partial quantities were permitted.

In some instances, it may be desirable to convert an RFQ into a reverse auction. For example, if the RFQ opportunity process does not produce bids that meet expectations, the initiator can convert the RFQ opportunity into a reverse auction, which may further drive down the supplier prices.

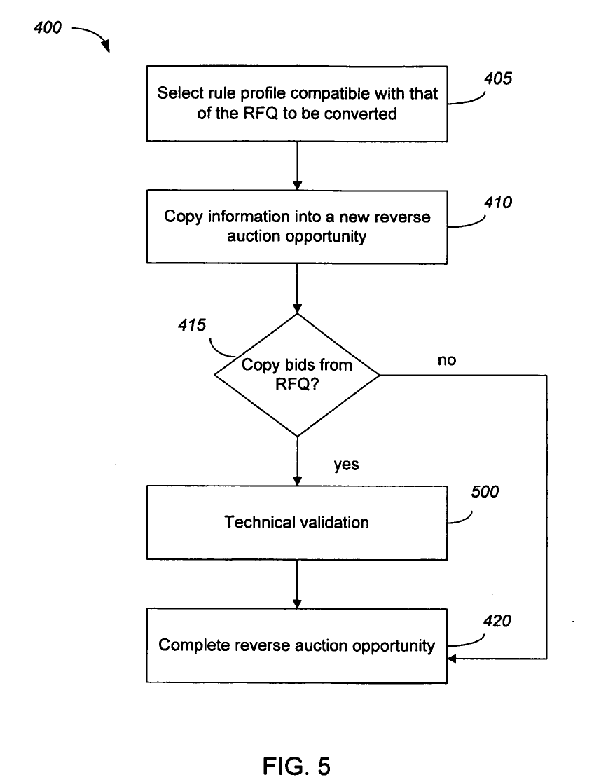

FIG. 5 is a flowchart describing an operation 400 for converting an RFQ opportunity into a reverse auction opportunity. The initiator may select a reverse auction profile compatible with the auction profile of the RFQ (block 405). All information in the RFQ, e.g., information in the header, line items, dynamic attributes, and attachments, may be copied into a new reverse auction opportunity. The initiator can modify or add information in the reverse auction opportunity (block 410). For example, the initiator may add a dynamic attribute or change a distribution list in the header. Also, if the reverse auction profile requires starting prices for the line items, the initiator may be prompted to add a starting price.

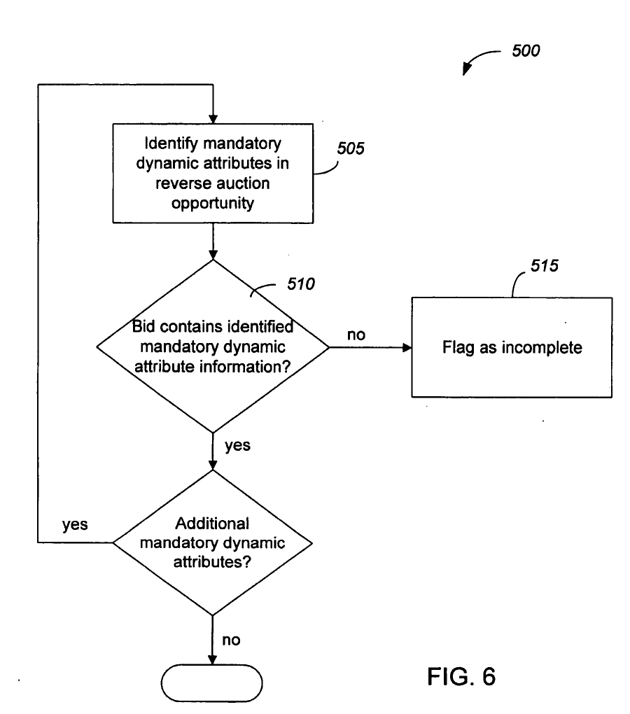

The initiator may copy bids received for the RFQ or discard them (block 415). A technical validation operation 500, shown in FIG. 6, may then be performed on the retained bids. The technical validation operation 500 determines if the bids are still valid for the reverse auction. Any mandatory dynamic attributes in the reverse auction opportunity are identified (block 505). For each identified mandatory dynamic attribute, the technical validation operation determines whether the bid contains the required information for the dynamic attribute (block 510). If the bid does not contain the required information, the bid is tagged as incomplete (block 515). For example, the initiator may have added a mandatory dynamic attribute that requires the supplier to enter a color in the bid. However, if this was not a dynamic attribute in the RFQ, the suppliers may not have specified a color in the bids copied over from the RFQ. These bids would fail technical validation, and these bids would be flagged as incomplete. The suppliers may then be given the opportunity to modify the bid to satisfy the new dynamic attribute. The initiator may then complete the reverse auction object (block 420).

A reverse auction based on a reverse auction object may be published or held as live auctions, which are typically fast-paced and highly competitive. There may be a rule for live reverse auctions which automatically extends the closing time defined in the header in response to bidding activity. For example, if bids are coming in at a predetermined, rapid frequency at the scheduled closing time, the auction may be extended, thereby enabling continued bidding. The continued bidding may further drive down prices on the line items. The auction may be extended for a predetermined time period, or until the frequency of bids falls below a predefined threshold.

When an initiator/purchaser creates or sets up an auction at the initiator computer 105 in FIG. 1, the auction creation software described above may prompt the initiator to assign a pre-configured auction profile to the auction or create an auction profile. The auction profile selection may be a drop-down box. At each customer site, there may be a limited number of pre-configured or created auction profiles. The auction profile controls the behavior of the bidding process in terms of bid validation and what information is accessible to the bidder during the bidding process.

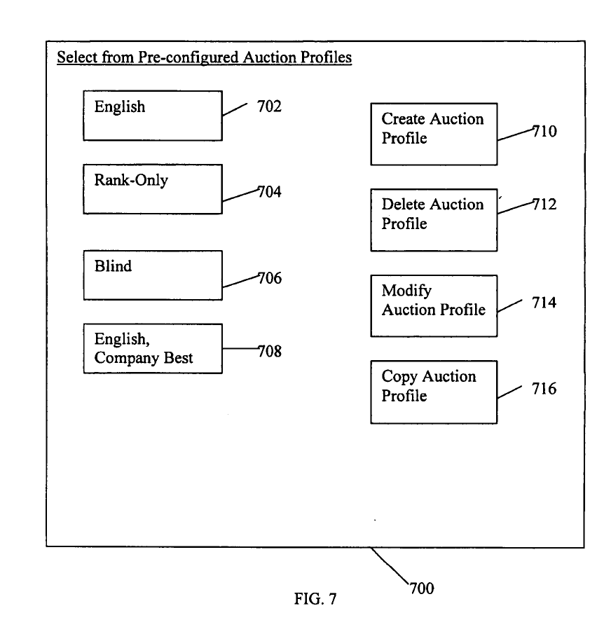

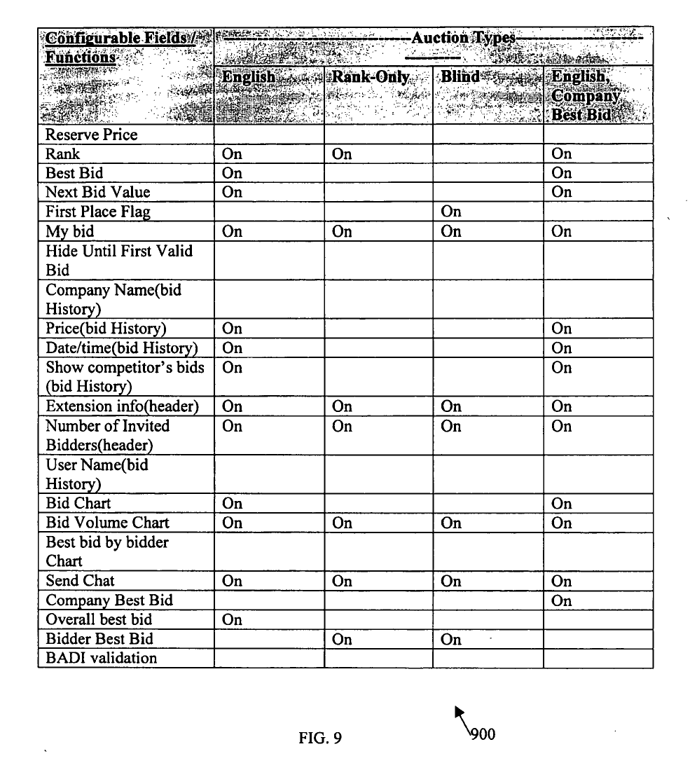

FIG. 7 is a screen 700 which may be displayed on the initiator computer 105 in FIG. 1. The screen 700 may be a part of an initiator's “cockpit.” The screen 700 allows an initiator to select from among a plurality of pre-configured auction profiles 702-708, e.g., English, Rank-only, blind, and English/company best bid, which have configurable fields/functions shown in FIG. 9. Other pre-configured auction profiles may be provided or created. The screen 700 also provides a create auction profile option 710, delete auction profile option 712, modify auction profile option 714 and copy auction profile option 716. The options in FIG. 7 may be buttons or hyperlink text for an initiator to select on the screen 700.

Once auction profiles are created, they can be changed at any time. The modify auction profile option 714 may allow the re-assigning of an auction profile. For example, an old auction that is meant as a kind of template may be copied.

An auction profile may be deleted. This is especially important when a initiator first sets up the auction system, tries out newly-created auction profiles, and finds that they are incorrect. An auction with a “deleted” auction profile should result in an error message if the auction if further processed.

A bidder may have the bidder's cockpit open while a published auction is being modified. In this case, it is possible that the bidder cockpits may change, e.g., initially show best bid and later (after a change in the auction profile) not show the best bid.

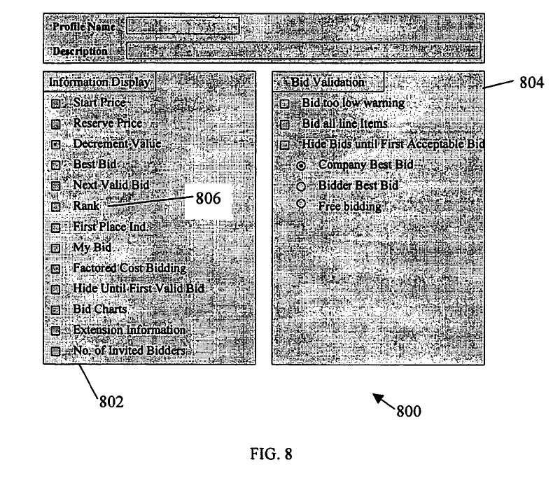

FIG. 8 is a sample screen 800 that may be displayed on the initiator computer 105 in FIG. 1. Various examples of the screen 800 may contain some or all of the configurable fields/functions in FIG. 9. The screen 800 shows a list of the individual rules with checkboxes, which can be selected by a user to create an auction profile. Other embodiments of the screen may include “yes” or “no” (or “enable” or “disable”) checkboxes. The screen 800 may include information display rules 802, which allow the initiator/purchaser and administrator/host to tailor the amount and type of auction information displayed to the bidder in bidder cockpits at supplier computers 110 in FIG. 1. The information display rules 802 may include a start price, reserve price, decrement value, best bid value, next valid bid value, rank of a bid, first place indicator/flag, my bid value, transform bidding, no bid input, bid charts, extension information and number of invited bidders.

A “reserve price” is set by the auction initiator/purchaser as a maximum amount that the purchaser is willing to pay to procure a good or service on a line item of an auction. The purchaser is not obligated to buy unless the bid price meets or falls below the reserve price. A reserve price dollar amount may be hidden from the bidders, but the bidder may know that there is a reserve price on a line item (or not), and whether the reserve price has been met.

“Decrement value” means a bid must be lower than the current leading bid by an amount equal to, or greater than, the decrement value, e.g. the current leading bid is $100 and the bid decrement value is $5. The next bid must be $95 or less in a reverse auction.

As an example, if the initiator does not want bidders to see their ranks, the initiator leaves a “rank” display option 806 unselected.

As another example, the initiator may decide that the best way to get the lowest price on buying widgets is to have a rank-only bidding, i.e. the bidders only see their current rank when they submit their bid, but do not see the current best bid, i.e., turn off an “overall best bid” display option in FIG. 9.

Conversely, the initiator may decide that the best way to get the lowest price on buying a different commodity is to only let the bidders know whether or not they are in first place (via the “first place indicator” in FIG. 8) but not know their explicit rank if they are not first place.

The screen 800 may also include bid validation rules 804. The bid validation rules 804 control how a newly submitted bid is validated. The bid validation rules 804 may include a bid too low warning, a bid all line items, a hide bids until first accepted bid, a company best bid, a bidder best bid and a free bidding.

Once an auction profile is created, the initiator may use the auction profile when the initiator creates an auction. Customizing auction profiles by selecting the rules in FIGS. 8 and 9 provides flexibility in running auctions.

FIG. 9 is a table 900 of four pre-configured auction profiles, e.g., English, Rank-only, Blind, and English Company Best Bid. The pre-configured auction profiles may be available with an auction creation software. The table 900 may include configurable fields/functions, such as reserve price, rank, best bid, next bid value, first place flag, my bid, hide until first valid bid, company name(bid history), price (bid history), date/time(bid history), show competitor's bids (bid history), extension info (header), number of invited bidders (header), user name (bid history), bid chart, bid volume chart, best bid by bidder chart, send chat, company best bid, overall best bid, bidder best bid, and BADI validation.

“BADI” stands for Business Add-In. This is a custom-code modification mechanism. It allows an implementer or consultant to modify the software in a modular way. One of the biggest benefits is that the modified code does not get overwritten if a new version or support pack of the software is installed later. In an online auction system, the BADI validation allows the implementer to provide special coding to custom-handle a bid validation. For example, the software may be pre-configured to validate any new bid that is lower than the current leading bid, i.e., if the leading bid is $110, the next bid cannot be greater than $110. But maybe the implementer wants a special kind of validation that the system does not support. For example, the implementer may want to implement a “Next Place” type of bidding, where the bidder just needs to bid low enough to move him up one place in the ranking. So in this case, if the current bids are: First Place=$110, Second Place=$120, Third Place=$130, Fourth Place=$140, and Bidder A is currently in Third Place with the $130 bid, his next bid just has to be $120, instead of the $110 that the system would normally invalidate. This is just an example of how an implementer may want to customize the bid validation by writing custom programming code that can be added into the system via a BADI.

“Number of Invited Bidders” may provide more competition and better buying prices if a bidder knows that there are, for example, 50 bidders total. This may be a count of the number of invited, non-banned bidders. So if there are 20 invited bidders, 10 bidders responded (this number is not relevant), and 4 are currently banned (maybe 6 were banned at some point, but two of them were re-instated), then the number of bidders should be 16. While the auction is in the published state, the auction is changeable. The buyer may continue to add or delete invited bidders on a published auction. While a bidder has a bidder cockpit open, the “number of bidders” should change accordingly.

The “Hide (bidding information) until first valid bid” rule in FIG. 9 prevents bidders from seeing any bid activity until the bidders actually participate. Price information may be highly sensitive, and non-serious bidders should not be able to sit at the sidelines and view their competitor's prices.

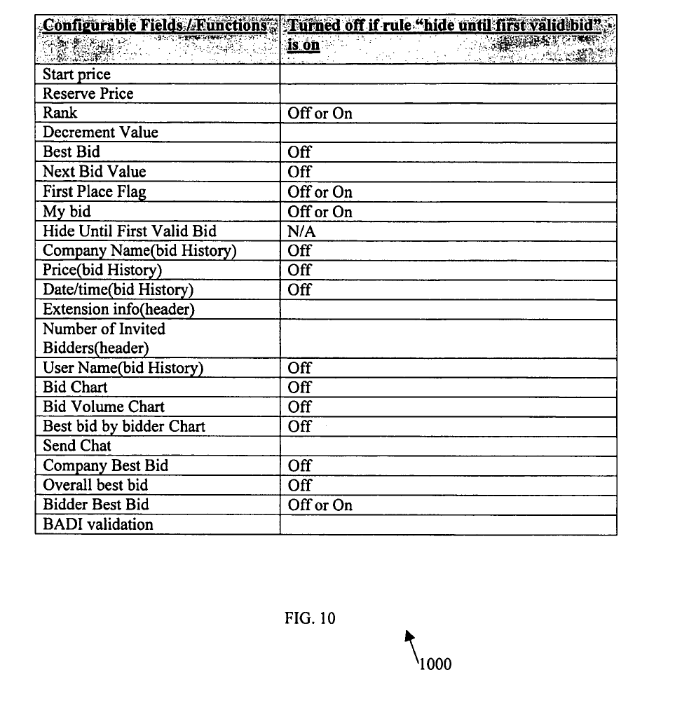

FIG. 10 is a table 1000 showing the behavior of a “hide until first valid bid” rule. “Off” in FIG. 10 means a field is temporarily turned off (or completely removed) until the bidder places a valid bid. The “Off” selection should temporarily supersede other rules. For example, an auction profile may be set to show “rank” and “best bid,” but not show the “number of invited bidders.” If the “hide until first valid bid” rule is also on, then the “rank” and “best bid” should NOT be shown initially until a first valid bid is received.

Blanks in FIG. 10 means that the “hide until first valid bid” does not control these fields, and the normal settings in the auction profile should control these fields. In the example above, the bidder would never see the number of invited bidders.

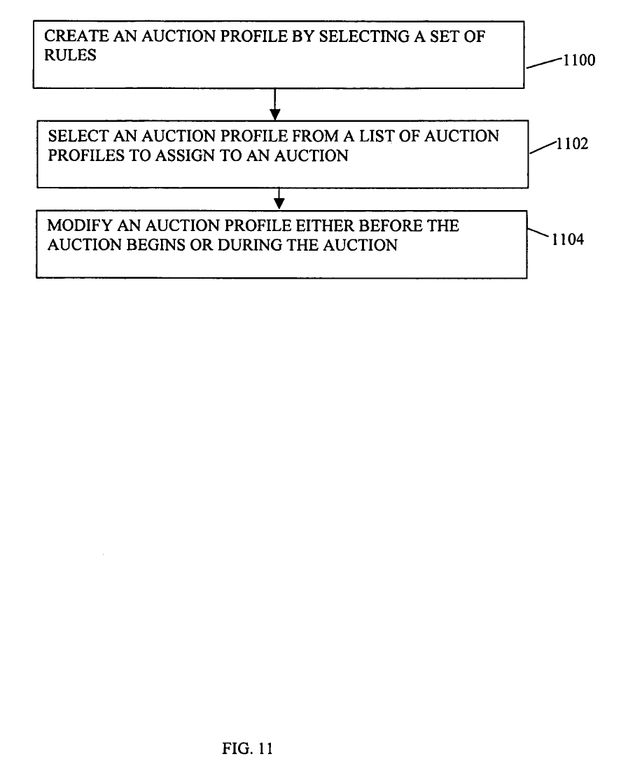

FIG. 11 is a flow chart showing a method of using auction profiles as described above. In block 1100, an initiator creates an auction profile by selecting a set of rules. In block 1102, the initiator selects an auction profile from a list of auction profiles to assign to an auction. In a block 1104, the initiator modifies an auction profile either before the auction begins or during the auction.

Various bid validation variations may be parameterized and customized via auction profiles. There may be several types of user interface bid validation rules.

Show Bid Details Only After First Acceptable Bid (or Hide until first valid bid in FIGS. 8-9) allows the purchaser to set a flag in the auction profile, for a certain auction, so that only after the bidder puts in an acceptable bid for at least one line item can he/she see the bidding details for the auction. Before the bidder puts in at least a valid bid, he/she cannot see any current bidding details, i.e., the bid history list, bid charts, rank, current best bid and next valid bid information are not available for display.

Alternatively, the flag may be set on a line item level for a certain auction. Hence, only details for the validly bid line items, e.g., charts and the bid price information, etc, become available for the bidder.

The Show Bid Details Only After First Acceptable Bid feature is designed to prevent the bidders from taking advantage of the monitoring and getting the bidding and pricing information, without true intension of participating the auction. Only after the bidder puts in a valid bid, which is legally binding can he/she be considered a “serious” bidder and be allowed the viewing of the auction bidding details.

One part of the system 100 may send forward the full bidding detail while the another part keeps track of the bidder to see whether he/she has posted a valid bid. If so, a computer 110 displays the full bidding detail.

Backend bid validation rules are used to evaluate the validity of bids coming through and rank them accordingly. The front end users should be transparent to the mechanism behind the scene.

Company Best Bid in FIGS. 8-9 allows the purchaser to set a flag in the auction profile to indicate that a particular auction is following the “company best bid” validation rule. The “company best bid” validation rule allows multiple bidders from the same company to bid in the same auction, competing on behalf of the company, and validates the bid by checking whether it is better (lower, in a reverse auction) than the current best (lowest) bid of all the bids by bidders within the same company. If so, the current company best bid is updated by the current bid. If not, the current bid is rejected and the current company best bid stays unchanged. The ranking is based on the best bid per company so all bidders from the same company would see the same ranking for the item.

From the user interface display, the bidders would see only his/her own rank and his/her last valid bid. A bidding history/chart should present his/her own bids as well.

The Company Best Bid feature is designed based on the requirement that multiple bidders, possibly responsible for supplying the same item, yet from different divisions of the company can bid on behalf of the company and be ranked as a single entity.

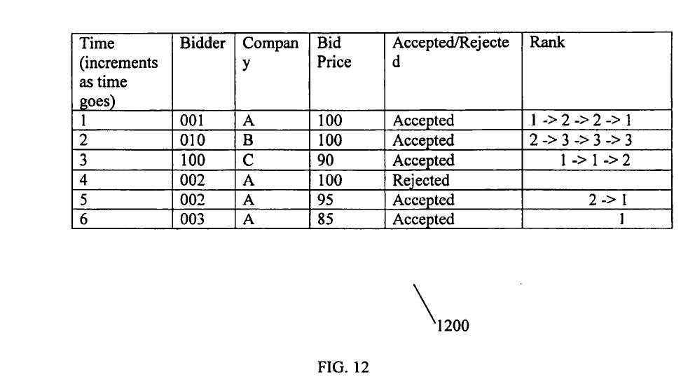

FIG. 12 is a table 1200 showing a possible bidding and ranking scenario for an item in the auction based on the company best bid validation rule.

Bidder Best Bid in FIGS. 8-9 allows the purchaser to set a flag in the auction profile to indicate that a particular auction is following the “bidder best bid” validation rule. The “bidder best bid” validation rule allows multiple bidders from the same company to bid in the same auction, as individual competitors, and validates the bid by checking whether the bid is better (lower, in a reverse auction) than the current best (lowest) bid of his own. If the bidder has never bid before, the start price is set to be the current best bid. If so, the current bidder best bid is updated by the current bid. If not, the current bid is rejected and the current bidder best bid stays un-changed. The ranking is based on the best bid per bidder and if same, the first bid takes priority.

From the user interface display at the computers 110 in FIG. 1, bidders would see only his/her own rank and his/her last valid bid. The bidding history/chart should present his/her own bids as well. Multiple bidders, possibly responsible for supplying the same item but from different divisions of the company, can bid on behalf of their own division and be ranked individually.

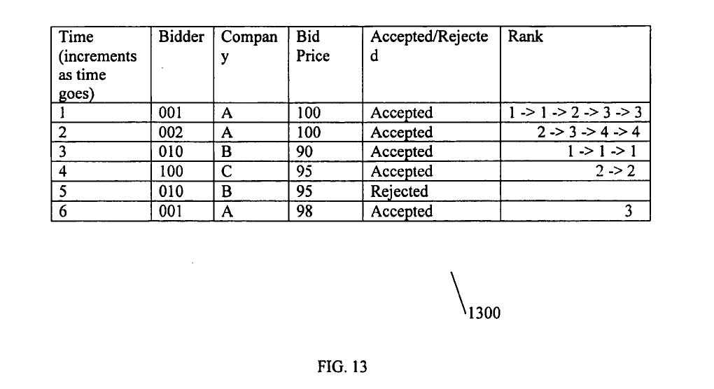

FIG. 13 is a table 1300 showing a possible bidding and ranking scenario based on the bidder best bid validation rule for an item in the auction.

Overall Best Best in FIG. 9 allows the purchaser to set a flag in the auction profile to indicate that a particular auction is following the “overall best bid” validation rule. This rule forces each bidder to submit a bid that must beat the overall leading bid for that line item, i.e., the bid must be lower than the current lowest price, regardless of whether the leading bid was placed by himself, someone from his company, or any other bidder.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

Although only a few embodiments have been described in detail above, other modifications are possible. The logic flows depicted in FIGS. 3-6 do not require the particular order shown, or sequential order, to achieve desirable results. For example, adding attachments to an opportunity object may be performed at many different places within the overall process. In certain implementations, multitasking and parallel processing may be preferable.

Other embodiments may be within the scope of the following claims.

1. A method comprising:
creating a plurality of auction profiles, each of said plurality of auction profiles including a subset of rules from a plurality of auction rules; and
assigning one of said plurality of auction profiles to an auction object.

2. The method of claim 1, wherein the auction rules control display of information to a plurality of bidders.

3. The method of claim 2, wherein the information to display to a plurality of bidders comprises at least one of reserve price, rank, best bid, next bid value, first place flag, my bid, hide until first valid bid, company name bid history, price bid history, date/time bid history, show competitor's bids history, extension information, number of invited bidders, user name bid history, bid chart, bid volume chart, best bid by bidder chart, send chat, company best bid, overall best bid, bidder best bid, and bid validation.

4. The method of claim 1, further comprising:
conducting an auction based on said auction object.

5. The method of claim 1, wherein said assigning is performed at an initiator site.

6. The method of claim 1, further comprising:
at one or more bidder sites, displaying a graphical user interface having a configuration including display objects dictated by the auction rules.

7. The method of claim 1, wherein creating a plurality of auction profiles comprises selecting a subset of rules from a plurality of pre-configured auction rules.

8. The method of claim 1, wherein assigning one of said plurality of auction profiles to an auction object comprises selecting an auction profile from among a plurality of pre-configured auction profiles.

9. The method of claim 8, wherein the plurality of pre-configured auction profiles comprise English, rank-only, blind, and English company best bid.

10. The method of claim 1, further comprising:
modifying an auction profile before the auction begins.

11. The method of claim 1, further comprising:
modifying an auction profile during the auction.

12. The method of claim 1, wherein the auction rules comprise bid validation rules.

13. The method of claim 12, wherein the bid validation rule shows bid details only after a first acceptable bid is received.

14. The method of claim 12, wherein the bid validation rule allows multiple bidders from a company to bid in the same auction and validates each bid by checking whether the bid is lower than the current lowest bid of the bids by bidders within the company.

15. The method of claim 12, wherein the bid validation rule allows multiple bidders from a company to bid in the same auction as individual competitors, and validates a bidder's bid by checking whether the bid is lower than the current lowest bid of the bidder.

16. The method of claim 12, wherein the bid validation rule forces each bidder to submit a bid that is lower than a current lowest bid for a line item.

17. A networked computer system comprising:
an initiator site operative to create an auction profile;
a server operative to host an online auction corresponding to the auction profile; and
a plurality of supplier sites operative to transmit bids to the auction site during the auction.

18. The networked computer system of claim 17, wherein the auction profile comprises rules that control display of information to a plurality of bidders for an online auction.

19. The networked computer system of claim 18, wherein the information to display to a plurality of bidders comprises at least one of reserve price, rank, best bid, next bid value, first place flag, my bid, hide until first valid bid, company name bid history, price bid history, date/time bid history, show competitor's bids history, extension information, number of invited bidders, user name bid history, bid chart, bid volume chart, best bid by bidder chart, send chat, company best bid, overall best bid, bidder best bid, and bid validation.

20. The networked computer system of claim 17, wherein the initiator site allows a user to create an auction profile by selecting a subset of rules from a plurality of pre-configured auction rules.

21. The networked computer system of claim 17, wherein the initiator site allows a user to select an auction profile from among a plurality of pre-configured auction profiles, each auction profile comprising a pre-configured set of auction rules that control display of information to a plurality of bidders for an auction.

22. The networked computer system of claim 21, wherein the plurality of pre-configured auction profiles comprise English, rank-only, blind, and English company best bid.

23. The networked computer system of claim 17, wherein the initiator site allows a user to modify an auction profile before the auction begins.

24. The networked computer system of claim 17, wherein the initiator site allows a user to modify an auction profile during the auction.

25. The networked computer system of claim 17, wherein the set of auction rules comprise a bid validation rule.

26. The networked computer system of claim 25, wherein the bid validation rule shows bid details only after a first acceptable bid is received.

27. The networked computer system of claim 25, wherein the bid validation rule allows multiple bidders from a company to bid in the same auction and validates each bid by checking whether the bid is lower than the current lowest bid of the bids by bidders within the company.

28. The networked computer system of claim 25, wherein the bid validation rule allows multiple bidders from a company to bid in the same auction as individual competitors, and validates a bidder's bid by checking whether the bid is lower than the current lowest bid of the bidder.

29. The networked computer system of claim 25, wherein the bid validation rule forces each bidder to submit a bid that is lower than a current lowest bid for a line item.
